(19) United States
(12) Patent Application Publication
(10) Pub. No.: US 2003/0139934 A1
(43) Pub. Date: Jul. 24, 2003

(54) Requesting and providing services via a registry

(75) Inventor: Sandip H. Mandera, Portland, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/027,440

(22) Filed: Dec. 20, 2001

(51) Int. Cl. G06F 17/60

(52) U.S. Cl. 705/1

(57) ABSTRACT

A method, apparatus, and signal-bearing media for fulfilling service requests by breaking a service request up into multiple sub-requests and using a registry server to find peers who can fulfill the sub-requests. The registry server contains an identification of services and the peers who may perform the services.

### FIELD

This invention relates generally to electronic devices and more particularly to requesting and providing services using a registry.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © Intel, Incorporated, 2001. All Rights Reserved.

### BACKGROUND

Providers, e.g., businesses, increasingly use the Internet to market and deliver their goods and services. But, providers face a problem in determining how to reach their potential customers, and customers face a problem in determining how to find and utilize an appropriate provider. Some customers attempt to use search engines (such as Yahoo, Lycos, Google, and Altavista) to find providers, but search engines return a large number of irrelevant web pages.

To make these problems even more complicated, customers often have the need for complex services that require more than one provider. For example, a customer might need both a stockbroker and a bank to complete a stock transaction, with no single entity providing both stock trading and banking services. Thus, the customer's problem of finding an appropriate provider is compounded for services that require multiple providers.

Without a solution that addresses these problems, both providers and customers will continue to be hampered in their ability to provide and utilize goods and services:

### BRIEF DESCRIPTION OF THE DRAWINGS

FIG. 1 depicts a block-diagram overview of the architecture of an embodiment of the invention.

FIG. 2 depicts a block diagram of a registry, according to an embodiment of the invention.

FIGS. 3A, 3B, and 3C depict block diagrams of requests, according to embodiments of the invention.

FIGS. 4A and 4B depict a block diagrams of responses, according to an embodiment of the invention.

FIG. 5a depicts a flowchart of example processing, according to an embodiment of the invention.

FIG. 5b depicts a flowchart of example processing, according to an embodiment of the invention.

FIG. 6 depicts a block diagram of a peer device, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

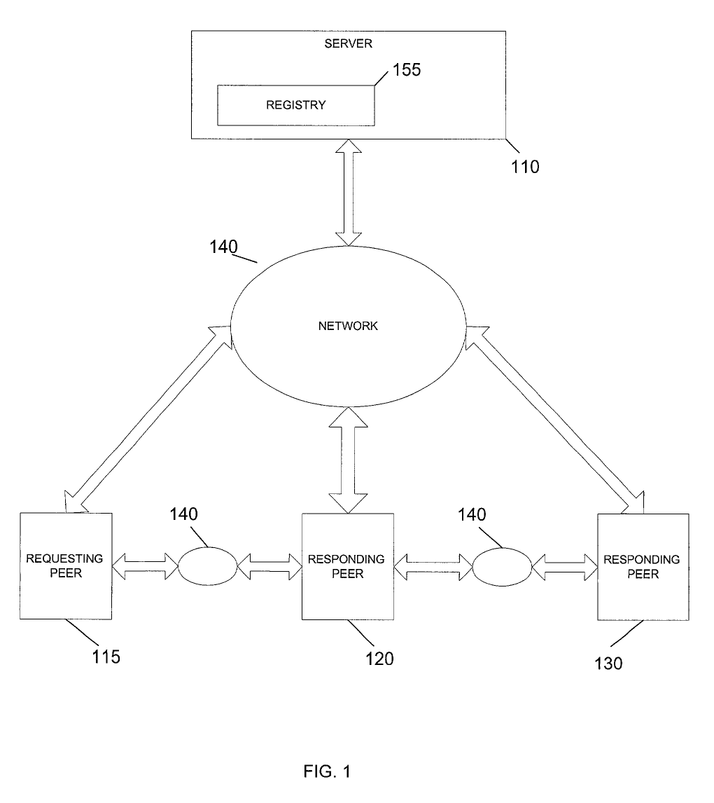

FIG. 1 depicts a block-diagram overview of the architecture of an embodiment of the invention. According to this embodiment, registry server 110 may provide registry services to requesting peer 115, responding peer 120, and responding peer 130 via network 140.

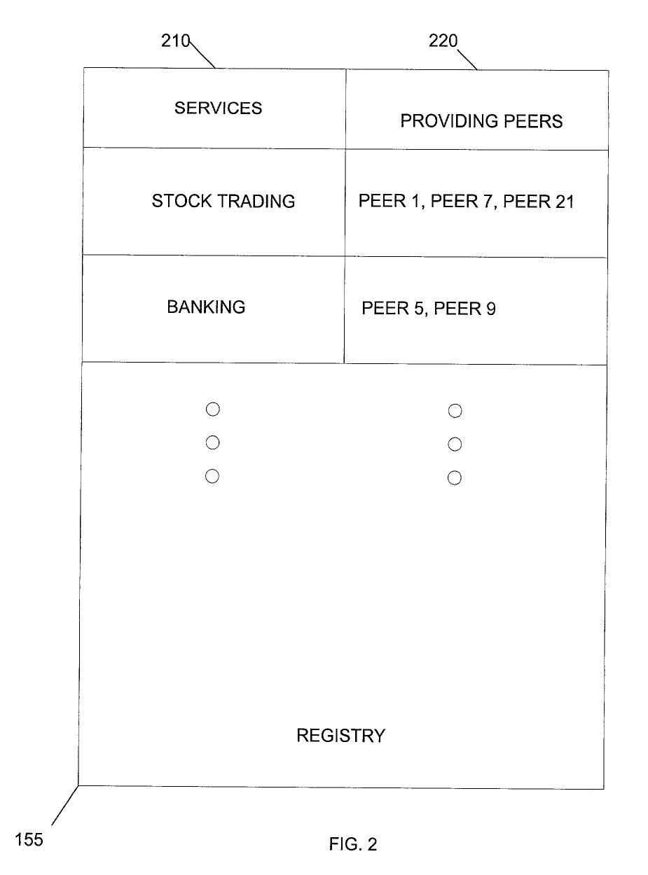

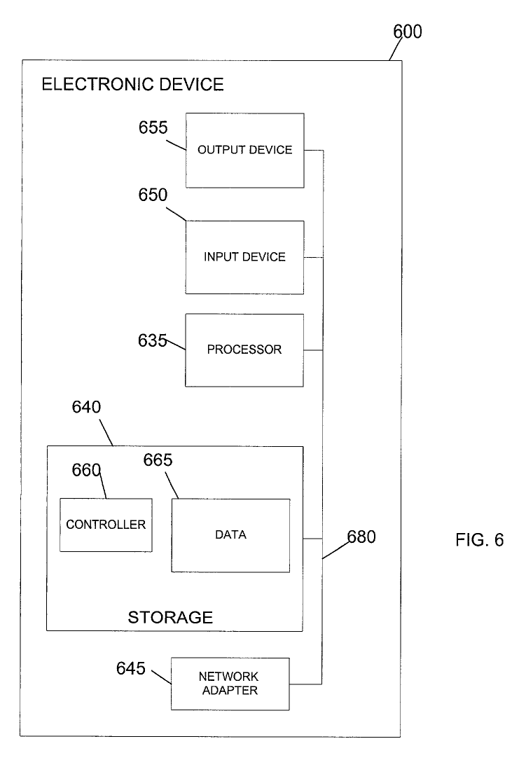

Registry server 110 may be an electronic device, as further described below with reference to FIG. 6. Although only one registry server is shown, in another embodiment multiple registry servers are present. Registry server 110 may include registry 155, which includes a list of available services and a list of identifiers of corresponding peers that can provide the services. As used herein, “services” may encompass both goods and/or services. Registry 155 is further described below with reference to FIG. 2.

Requesting peer 115 may be an electronic device, as further described below with reference to FIG. 6. Although only one requesting peer is shown, in another embodiment, any number of requesting peers may be present. In an embodiment, requesting peer 115 may also act as a responding peer.

Responding peer 120 may be an electronic device, as further described below with reference to FIG. 6. In an embodiment, responding peer 120 may also act as a requesting peer.

Responding peer 130 may be an electronic device, as further described below with reference to FIG. 6. In an embodiment, responding peer 130 may also act as a requesting peer.

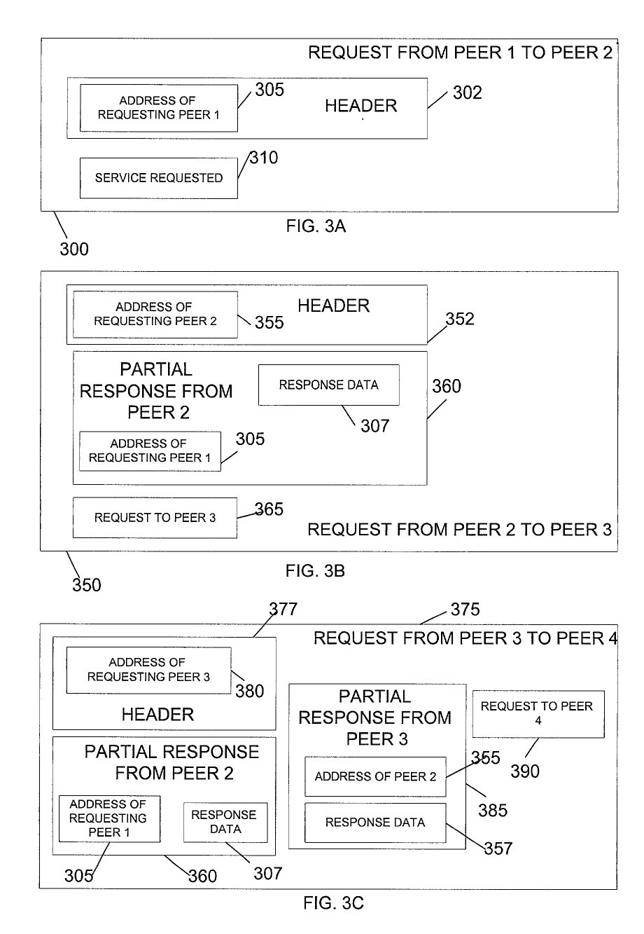

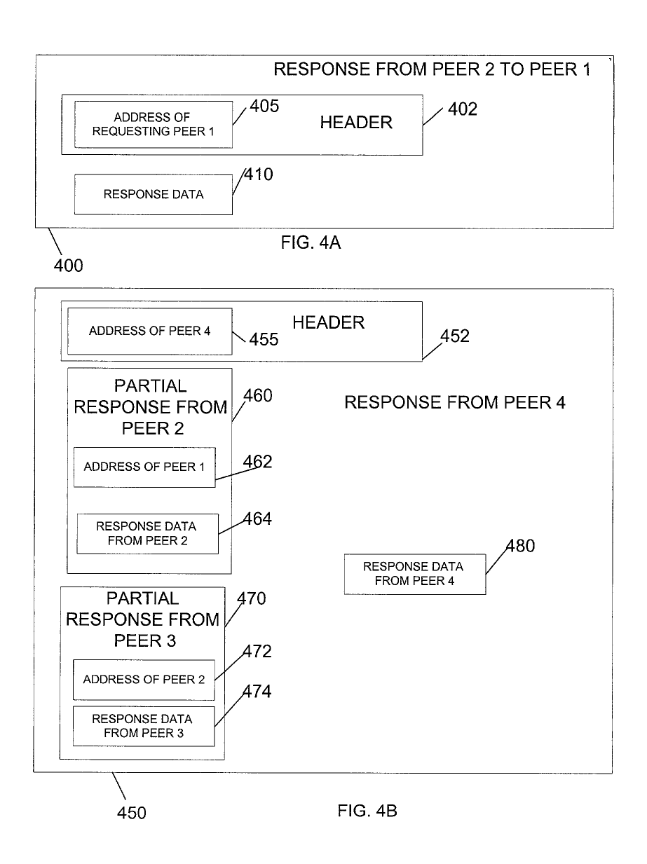

Requesting peer 115 may send service requests to responding peer 120 who may fulfill the service request completely by itself, or with the help of responding peer 136, and may send a response back to requesting peer 115. Requests and responses are further described below with reference to FIGS. 3 and 4, respectively. Although requesting peer 115 is shown connected to responding peer 120 via network 140 while responding peer 120 is shown connected to responding peer 130, in another embodiment any appropriate network topology may exist between requesting peer 115, responding peer 120, and responding peer 130.

Network 140 may be any suitable network and may support any appropriate protocol suitable for communication between registry server 110 and peers 115, 120, and 130. In an embodiment, network 140 may support wireless communications. In another embodiment, network 140 may support hard-wired communications, such as a telephone line or cable. In another embodiment, network 140 may be the Internet and may support IP (Internet Protocol). In another embodiment, network 140 may be a local area network (LAN) or a wide area network (WAN). In another embodiment, network 140 may be an IEEE (Institute of Electrical and Electronics Engineers) 802.11B wireless network. In still another embodiment, network 140 may be any suitable network or combination of networks. Although one network 140 is shown, in other embodiments any number of networks (of the same or different types) may be present and various peers and registry servers may use the same network or different networks.

FIG. 2 depicts a block diagram of example contents of registry 155, according to an embodiment of the invention. Registry 155 may include services field 210 and corresponding providing-peers field 220. Services field 210 may include a list of services. In the example shown banking and stock trading are listed as services, but in other embodiments any appropriate services may be used. Corresponding providing-peers field 220 may include an identification of the corresponding peer or peers who provide the services. The identifiers shown in corresponding providing-peers field 220 are merely examples, and any appropriate identifiers may be used.

In one embodiment, registry 155 may be implemented in XML (Extensible Markup Language). In another embodiment, registry 155 may be implemented in ebXML (Electronic Business XML). In another embodiment, registry 155 may be implemented in a UDDI (Universal Description, Discovery, and Integration) specification. In another embodiment, registry 155 may be implemented in EDI (Electronic Data Interchange). In another embodiment, registry 155 may be implemented in any appropriate format.

FIG. 3A depicts a block diagram of example contents of request 300 from peer 1 to peer 2, according to an embodiment of the invention. Request 300 includes header 302 and service requested 310. Header 302 includes address of requesting peer 1 305.

FIG. 3B depicts a block diagram of example contents of request 350 from peer 2 to peer 3, according to an embodiment of the invention. Peer 2 has received request 300 from peer 1 and is only able to partially fulfill the request, so peer 2 has fulfilled the portion of the request that it is able to fulfill and has built request 350 to peer 3 to fulfill the rest.

Request 350 includes header 352, partial response from peer 2 360, and request to peer 3 365. Header 352 includes address of requesting peer 2 355. Partial response 360 includes address of requesting peer 1 305, and response data 307, which may be created by peer 2.

FIG. 3C depicts a block diagram of example contents of request 375 from peer 3 to peer 4, according to an embodiment of the invention. Peer 3 has received request 350 from peer 2 and is only able to partially fulfill the request, so peer 3 has fulfilled the portion of the request that it is able to fulfill and has built request 375 to peer 4 to fulfill the rest. Request 375 includes header 377, partial response from peer 2 360, partial response from peer 3 385 and request to peer 4 390. Header 377 includes address of requesting peer 3 380. Partial response 360 includes address of requesting peer 1 305 and response data 307, which may be created by peer 2. Partial response 385 includes address of peer 2 355 and response data 357, which may be created by peer 3. Requests 350 and 375 are sub-requests of the total request.

FIG. 4A depicts a block diagram of example contents of response 400 from peer 2 to peer 1, according to an embodiment of the invention. Response 400 is used when peer 2 is able to fully fulfill the service requested by request 300. Response 400 includes header 402 and response data 410. Header 402 includes address of requesting peer 1 405.

FIG. 4B depicts a block diagram of response 450 from peer 4 to peer 3, according to an embodiment of the invention. Response 450 may be used by peer 4 when multiple peers have been used to provide the service requested by peer 1. Although peers 1, 2, 3, and 4 are shown in this example, in other embodiments, any number of peers may be used.

Response 450 from peer 4 to peer 3 includes header 452, partial response from peer 2 460, partial response from peer 3 470 and response data from peer 4 480. Header 452 includes address of peer 4 455. Partial response from peer 2 460 includes address of peer 1 462 and response data from peer 2 464. Partial response from peer 3 470 includes address of peer 2 472 and response data from peer 3 474. Partial responses 460, 470, and 480 are sub-responses of the total response.

Scenario 1:

The following is example of XML tags for a request and response where the responding peer is able to completely satisfy the requesting peer's need:

Simple request

<SOAP-ENV:Envelope
xmlns:SOAP-ENV=URL of the XML soap envelope
xmlns:xsi=URL of the XML Schema instance
xmlns:xsd=URL of the XML Schema
<SOAP-ENV:Header>

<t:TransactionId xmlns:t=“URL pointing to webservice”

SOAP-ENV=mustUnderstand=“1”>

<AddressofRequestPeer1>
XXX.XXX.XX.XX
</AddressofRequestPeer1>

xxx

</t:TransactionId

</SOAP-ENV:Header>
<SOAP-ENV:Body>

<m:name-of-the-webservice xmlns:m=URL-pointing-to-webservice
SOAP-ENV:encodingStyle=

http://schemas.xmlsoap.org/soap/encoding/>

<data xsi:type=“xsd:datatype”>datavalue</amount>
</m:name-of-the-webservice>

</SOAP-ENV:Body>

</SOAP-ENV:Envelope>
Simple Response:
<SOAP-ENV:Envelope>

xmlns:SOAP-ENV=URL of the XML soap envelope
xmlns:xsi=URL of the XML Schema instance
xmlns:xsd=URL of the XML Schema
<SOAP-ENV:Header>

<t:TransactionId xmlns:t=URL-pointing-to-webservice, e.g. a bank or stock

broker

SOAP-ENV=mustUnderstand=“1”>

<AddressofRequestingPeer1>

XXX.XXX.XX.XX

</AddressofRequestPeer1>
xxx
</t:TransactionId

</SOAP-ENV:Header>
<SOAP-ENV:Body>

<m: name-of-the-webservice-or-some-identifier

xmlns:m=URL-pointing-to-webservice

SOAP-ENV:encodingStyle=

(URL of XML soap encoding)

<successIndicator xsi:type=“xsd:datatype”>Some-response</ successIndicator>
</m: name-of-the-webservice-or-some-identifier>

</SOAP-ENV:Body>

</SOAP-ENV:Envelope>

Scenario 2:

The scenario below depicts a request and response where the responding peer is unable to completely satisfy the requesting peer's need, so services from additional peers are required. The request from the first peer remains the same as above, but the subsequent response and request change, as further described below.

Partial Response at first responding peer i.e. Peer 2:
<SOAP-ENV:Envelope>

xmlns:SOAP-ENV=URL of XML soap envelope
xmlns:xsi=URL of XML Schema instance
xmlns:xsd=URL of XML Schema
<SOAP-ENV:Header>

<AddressofRequestingPeer1>

XXX.XXX.XX.XX

<AddressofRequestPeer1>

</SOAP-ENV:Header>
<SOAP-ENV:Body>

<m: name-of-the-webservice-or-some-identifier-Response

xmlns:m=URI-pointing-to-webservice

<Some-response>
</Some-response>

</SOAP-ENV:Body>

</SOAP-ENV:Envelope>
Request from responding peer 2 to peer 3:
<SOAP-ENV:Envelope>

xmlns:SOAP-ENV=URL of XML soap envelope
xmlns:xsi=URL of XML Schema instance
xmlns:xsd=URL of XML Schema
<SOAP-ENV:Header>

<AddressofRequestingPeer2>

XXX.XXX.XX.XX

<K/AddressofRequestPeer2>

</SOAP-ENV:Header>
<SOAP-ENV:Body>

<Partial-Response-from-Peer2>

//This contains IP address of Peer 1

</Partial-Response-from-Peer2>
<Some request to a responding peer say Peer 3>
</Some request to a responding peer say Peer 3>

</SOAP-ENV:Body>
</SOAP-ENV:Envelope>
Peer 3: Partial Response
<SOAP-ENV:Envelope>

xmlns:SOAP-ENV=URL of XML soap envelope
xmlns:xsi=URL of XML Schema instance
xmlns:xsd=URL of XML Schema
<SOAP-ENV:Header>

<AddressofRequestingPeer3>

XXX.XXX.XX.XX

</AddressofRequestPeer3>

</SOAP-ENV:Header>
<SOAP-ENV:Body>

<Partial-Response-from-Peer2>

</Partial-Response-from-Peer2>

<Some-response>
</Some-response>

</SOAP-ENV:Body>

</SOAP-ENV:Envelope>
Peer 3: Request to Peer 4^{h}
<SOAP-ENV:Envelope>

xmlns:SOAP-ENV=INK“URL of XML soap envelope
xmlns:xsi=URL of XML Schema instance
xmlns:xsd=URL of XML Schema
<SOAP-ENV:Header>

<AddressofRequestingPeer3>

XXX.XXX.XX.XX

</AddressofRequestPeer3>

</SOAP-ENV:Header>
<SOAP-ENV:Body>

<Partial-Response-from-Peer2>

//This contains IP address of Peer 1

</Partial-Response-from-Peer2>
<Partial-Response-from-Peer3>

//This contains IP address of Peer 2

</Partial-Response-from-Peer3>

</SOAP-ENV:Body>

</SOAP-ENV:Envelope>
Peer n: Response from this peer, which fulfills complete request
<SOAP-ENV:Envelope>

xmlns:SOAP-ENV=URL of XML soap envelope
xmlns:xsi=URL of XML Schema instance
xmlns:xsd=URL of XML Schema
<SOAP-ENV:Header>

<AddressofRequestingPeer n>

XXX.XXX.XX.XX

</AddressofRequestPeer n>

</SOAP-ENV:Header>
<SOAP-ENV:Body>

<Partial-Response-from-Peer2>

//This contains IP address of Peer 1
</Partial-Response-from-Peer2>
<Partial-Response-from-Peer3>

//This contains IP address of Peer 2

</Partial-Response-from-Peer3>

<Some-response>
</Some-response>

</SOAP-ENV:Body>

</SOAP-ENV:Envelope>

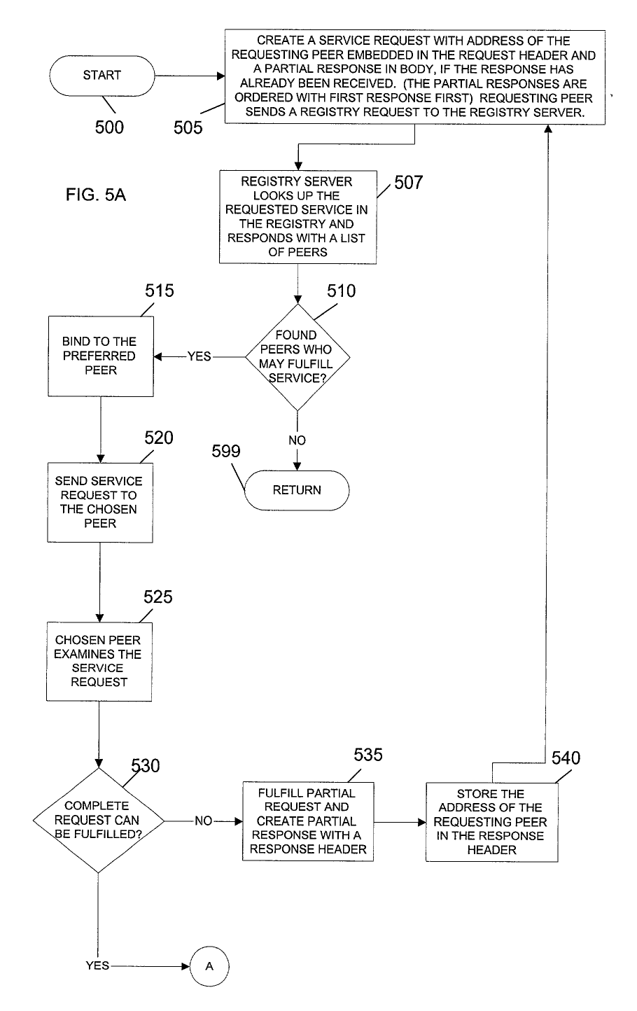

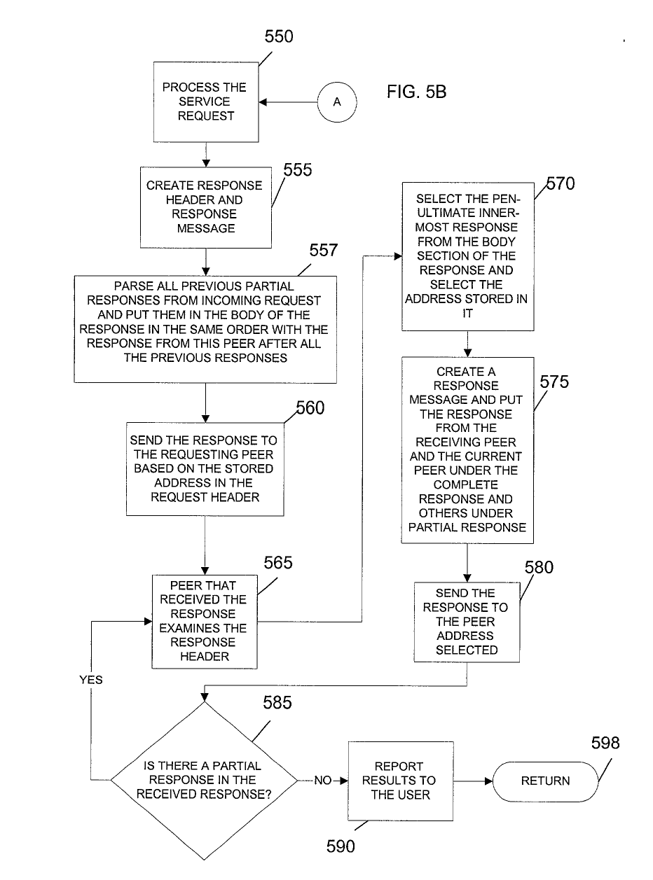

FIGS. 5a and 5b depict flowcharts of example processing at requesting peers, responding peers, and registry servers according to an embodiment of the invention. Control begins at block 500. Control then continues to block 505 where a requesting peer creates a service request with the address of the requesting peer embedded in the request header. A partial response is also embedded in the body of the request if a response has been received. The partial responses are ordered with the first response first. The requesting peer also sends a registry request for a particular service to registry server 110. Control then continues to block 507 where registry server 110 finds the requested service in registry 155 and returns an identification of a peer or peers who can provide the service if listed in registry 155. Control then continues to block 510 where the requesting peer determines whether registry server 110 found a peer to provide the previously-requested service. If the determination at block 510 is false, then no peer is available to fulfill the requested service, so control continues to block 599 where the function returns.

If the determination at block 510 is true, then a peer or peers are identified as providing the requested service, so control continues to block 515 where the requesting peer chooses among the peers identified by registry server 110. In an embodiment, the requesting peer chooses between the identified peers based on geographic proximity, performance, price, quality, or any other appropriate criteria. Then, the requesting peer binds, or connects, itself to the chosen peer. Control then continues to block 520 where the requesting peer sends the service request, which was previously created at block 505, to the chosen peer. Control then continues to block 525 where the responding peer receives and examines the service request.

Control then continues to block 530 where the responding peer determines whether the services requested by the service request can be completely fulfilled by the responding peer. If the determination at block 530 is false, then the responding peer must break up the service request into sub-requests, fulfill the sub-request that it is capable of fulfilling, and find another peer or peers that can handle the remaining sub-requests, so control continues to block 535 where the responding peer fulfills the portion of the request that it is capable of fulfilling. The responding peer also creates a partial response with a response header for that portion. Control then continues to block 540 where the responding peer stores the address of the requesting peer in the response header that was previously created in block 535. The responding peer does not yet send the partial response back to the requesting peer because all of the services requested by the requesting peer are not yet done. Instead, the responding peer must now find another peer to fulfill the remaining portion of the request, so control returns to block 505, as previously described above, where the responding peer becomes a requesting peer for the remaining services that it could not fulfill by itself.

If the determination at block 530 is true, then control continues to block 550 of FIG. 5B where the responding peer processes the service request and performs the requested service. Control then continues to block 555 where the responding peer creates the response header and response message. Control then continues to block 557 where the responding peer parses all previous responses from the incoming request and puts them in the body of the response in the same order with the response from this peer after all the previous responses. Control then continues to block 560 where the responding peer sends the response to the requesting peer based on the stored address in the request header. Control then continues to block 565 where the peer that received the response examines the response header.

Control then continues to block 570 where the peer that received the response selects the penultimate inner-most response from the body section of the response and selects the address stored in it. Control the continues to block 575 where the peer that received the response creates a response message and puts the response from the receiving peer and the current peer under the complete response and others under the partial response. Control then continues to block 580 where the receiving peer sends the response to the peer having the selected address.

Control then continues to block 585 where the peer that receives the response that was previously sent at block 580 determines whether there is a partial response in the response received. If the determination at block 585 is true, then control returns to block 565 as previously described above.

If the determination at block 585 is false, the control continues to block 590 where the receiving peer reports the results of the performed service to the user. Control then returns to block 598 where the function returns.

FIG. 6 depicts a block diagram of electronic device 600, according to an embodiment of the invention. Electronic device 600 may represents any or all of registry server 110, requesting peer 115, responding peer 120, and/or responding peer 130, as previously described above with reference to FIG. 1. Electronic device 600 may include processor 635, storage device 640, network adapter 645, input device 650, and output device 655, all communicatively coupled via bus 680.

Processor 635 may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 635 may execute instructions and may control the operation of the entire electronic device. Although not depicted in FIG. 6, processor 635 typically includes a control unit that organizes data and program storage in memory and transfers data and other information between the various parts of the electronic device. Processor 635 may receive input data, e.g., requests, from network 140 via network adapter 645, read and store code and data in storage device 640, and may present output data, e.g. responses, via network adapter 645 to network 140. Processor 635 may transmit and receive packets of information across network 140 using network adapter 645.

Although electronic device 600 is shown to contain only a single processor and a single bus, the present invention applies equally to electronic devices that may have multiple processors and to electronic devices that may have multiple buses with some or all performing different functions in different ways.

Storage device 640 represents one or more mechanisms for storing data. For example, storage device 640 may include read-only memory (ROM), random-access memory (RAM), magnetic disk storage media, optical storage media, flash memory devices, and/or other machine-readable media. Although only one storage device 640 is shown, multiple storage devices and multiple types of storage devices may be present. Further, although electronic device 600 is drawn to include storage device 640, the storage device may be distributed across other electronic devices attached via network 140. Storage device 640 may include controller 660 and data 665. Of course, storage device 640 may also include additional software and data (not shown), which are not necessary to understanding the invention.

Controller 660 may include instructions capable of being executed on processor 635 to carry out the functions of the present invention, as further described above with reference to FIGS. 5a and/or 5b. In another embodiment, some or all of the functions of the present invention may be carried out via hardware in lieu of a processor-based system. Data 665 may include registry 155, request 300, request 350, request 375, response 400, and/or response 450, as previously described above with reference to FIGS. 1, 3A, 3B, 3C, 4A, and 4B.

Input device 650 may accept input from a user. In an embodiment, input device 650 may be a keyboard, but in other embodiments, input device 650 may be a pointing device, mouse, trackball, keypad, touch-pad, touch screen, pointing stick, microphone, or any other appropriate input device. Although only one input device 650 is shown, in other embodiments any number of input devices of the same or of a variety of types may be present. In another embodiment, input device 650 may not be present.

Output device 655 communicates information to the user of electronic device 600. Output device 655 may be a cathode-ray tube (CRT) based video display well known in the art of computer hardware. But, in other embodiments output device 655 may be replaced with a liquid crystal display (LCD) based or gas, plasma-based, flat-panel display. In still other embodiments, any appropriate display device may be used. In yet other embodiments, a speaker that produces audio output may be used. Although only one output device 655 is shown, in other embodiments, any number of output devices of different types or of the same type may be present. In another embodiment, output device 655 may not be present.

Bus 680 represents one or more busses (e.g., PCI, ISA (Industry Standard Architecture), X-Bus, EISA (Extended Industry Standard Architecture), or any other appropriate buses and bridges (also termed bus controllers).

Network adapter 645 facilitates communication between electronic device 600 and network 140. Network adapter 645 provides electronic device 600 with a means of electronically communicating information, such as requests 300, 350, and 375 and responses 400 and 450 with other peers as well as communicating registry information with registry server 110. In another embodiment, network adapter 645 may support distributed processing, which enables electronic device 600 to share a task with other devices linked to network 140. Although network adapter 645 is shown as part of electronic device 600, in another embodiment they may be packaged separately. Although only one network adapter 645 is shown, in other embodiments, multiple network adapters of the same or of a variety of types may be present.

Electronic device 600 may be implemented using any suitable hardware and/or software, such as a personal computer. Portable computers, laptop or notebook computers, mainframe computers, minicomputers, network computers, tablet computers, pocket computers, pagers, cellular phones, and PDAs (Personal Digital Assistants) are examples of other possible configurations. The hardware and software depicted in FIG. 6 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports services.

As described in detail above, aspects of an embodiment pertain to specific apparatus and method elements implementable on electronic devices. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium (e.g., read-only memory devices within an electronic device, such as a CD-ROM readable by a CD-ROM drive;

(2) alterable information stored on rewriteable storage media (e.g., a hard disk drive or diskette); or

(3) information conveyed to an electronic device by a communications medium, such as through a computer or telephone network accessed via network adapter 645 including wireless communications.

Such signal-bearing media, when carrying processor-readable instructions that direct the functions of the present invention, represent embodiments of the present invention.

What is claimed is:

1. A method comprising:
receiving a service request;
fulfilling a portion of the service request; and
requesting a remaining portion of the service request from a peer.

2. The method of claim 1, wherein requesting the remaining portion further comprises:
creating a partial response to the service request.

3. The method of claim 2, wherein requesting the remaining portion further comprises:
creating another service request; and
including the partial response in the another service request.

4. The method of claim 1, wherein requesting the remaining portion further comprises:
sending a registry request to a registry server.

5. The method of claim 4, further comprising:
receiving a response to the registry request; and
choosing the peer from a plurality of peers in the response.

6. The method of claim 5, wherein choosing the peer further comprises:
choosing the peer based on geography.

7. The method of claim 5, wherein choosing the peer further comprises:
choosing the peer based on price.

8. A peer comprising:
a controller to break a service request into a first and second sub-requests, complete the first sub-request, find another peer, and to send the second sub-request to the another peer.

9. The peer of claim 8, wherein the controller is further to send a registry request to a registry server to find the another peer.

10. The peer of claim 8, wherein the controller is further to create a response to the first sub-request and store an address of a requesting peer in the response, wherein the requested peer initiated the service request.

11. The peer of claim 10, wherein the controller is further to embed the response in the second sub-request to the another peer.

12. A data structure stored on a machine-readable medium, wherein the data structure comprises:
a header field to store an address of a second peer;
a response field to store an address of a first peer and a first sub-response to a first sub-request, wherein the first sub-response is created by the second peer; and
a request field to store a second sub-request for service from the second peer to a third peer.

13. The data structure of claim 12, wherein the first sub-request and the second sub-request are components of a service request from the first peer.

14. The data structure of claim 13, wherein the second peer is to break the service request into the first sub-request and the second sub-request, perform the first sub-request, and store the address of the first peer in the response field.

15. A response data structure stored on a machine-readable medium, wherein the response data structure comprises:
a header field to store an address of a third peer;
a first response field to store an address of a first peer and a first sub-response to a first sub-request, wherein the first sub-response is created by the second peer; and
a second response field to store a second sub-response to a second sub-request, wherein the third peer created the second sub-response.

16. The response data structure of claim 15, wherein the second peer created the first sub-request and the second sub-request from a request.

17. The response data structure of claim 16, wherein the request originated from the first peer.

18. A signal-bearing medium comprising instructions, wherein the instructions when read and executed by a processor comprise:
fulfilling a service request, wherein fulfilling the service request further comprises creating response data;
creating a response to the service request;
copying a partial response from the service request to the response; and
inserting the response data in the response following the partial response.

19. The signal-bearing medium of claim 18, wherein the instructions farther comprise:
sending the response to an electronic device, wherein the electronic device is identified in the service request.

20. The signal-bearing medium of claim 18, wherein creating the response to the service request further comprises:
creating a response header comprising an address of a peer that creates the response data.

21. The signal-bearing medium of claim 18, wherein the partial response comprises an address of a peer to receive the partial response and second response data from a partial request.

22. An apparatus comprising:
a server comprising
a registry comprising identifications of services and identifications of peers that perform the services; and
a second electronic device to receive a service request from a first electronic device, to fulfill a portion of the service request, to find a third electronic device using the registry server, and to send a remaining portion of the service request to the third electronic device.

23. The apparatus of claim 22, wherein the third electronic device is to fulfill the remaining portion of the service request and to send a response to the second electronic device.

24. The apparatus of claim 23, wherein the third electronic device is to fulfill the remaining portion of the service request by itself.

25. The apparatus of claim 23, wherein the third electronic device is to use a fourth electronic device to fulfill the remaining portion of the service request.
